(19) United States
(12) Patent Application Publication
(10) Pub. No.: US 2004/0257459 A1
(43) Pub. Date: Dec. 23, 2004

(54) Method of controlling portable digital apparatus where folder icons move

(75) Inventor: Min-jung Shim, Busan Metropolitan City (KR)

Correspondence Address: GARDNER CARTON & DOUGLAS LLP, ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 10/838,590

(22) Filed: May 4, 2004

(30) Foreign Application Priority Data
Jun. 18, 2003 (KR) 2003-39344

(51) Int. Cl. H04N 5/222

(52) U.S. Cl. 348/333.02; 348/333.01; 348/333.12

(57) ABSTRACT

Provided is a method of controlling a portable digital apparatus which includes a display panel that displays a plurality of folder icons used to set operating conditions of the portable digital apparatus. The method allows a user to select one among the plurality of folder icons. The method includes selecting a folder icon by displaying a fixed selection-frame whose position is fixed on a screen of the display panel and by moving all of the folder icons sequentially according to the user's operation so that each folder icon is positioned in the fixed selection-frame in order, and controlling a setup by controlling a folder icon positioned in the fixed selection-frame to be an operation target selected by the user.

### BACKGROUND OF THE INVENTION

This application claims the priority of Korean Patent Application No. 2003-39344, filed on Jun. 18, 2003, in the Korean Intellectual Property Office, the disclosure of which is incorporated herein by reference.

1. Field of the Invention

The present invention relates to a method of controlling a portable digital apparatus, and more particularly, to a method of controlling a portable digital apparatus where a plurality of folder icons are displayed on a display panel so that a user can select one among the folder icons to set operating conditions of the portable digital apparatus.

2. Description of the Related Art

A conventional portable digital apparatus, for example, a digital camera disclosed in U.S. Pat. No. 6,167,469, displays a plurality of icons and an active cursor to allow a user to set operating conditions of the portable digital apparatus. The active cursor is moved by operating direction buttons to select a folder icon.

With such conventional portable digital apparatus, when folder icons are too numerous to be displayed all together on a single screen, it can be difficult for a user to immediately recognize the current position of an operation target. For example, fourteen folder icons might be displayed over two screens. The first through seventh folder icons are displayed on a first screen, and as soon as an active cursor moves from the seventh folder icon to an eighth folder icon, the eighth through fourteenth folder icons are displayed on a second screen. In such a case, the user may not be able to immediately recognize the current position of the operation target due to a change in a screen page.

### SUMMARY OF THE INVENTION

The present invention provides a method of controlling a portable digital apparatus to allow a user to immediately recognize the current position of an operation target even when folder icons for setting operation conditions of the portable digital apparatus are too numerous to be displayed on a single screen.

An aspect of the present invention provides a method of controlling a portable digital apparatus that includes a display panel that displays a plurality of folder icons used to set operating conditions of the portable digital apparatus. The method allows a user to select one icon among the plurality of folder icons. The method comprises selecting a folder icon by displaying a fixed selection-frame whose position is fixed on a screen of the display panel and by moving all of the folder icons sequentially according to the user's operation so that each folder icon is positioned in the fixed selection-frame in order, and controlling a setup by controlling a folder icon positioned in the fixed selection-frame to be an operation target selected by the user.

Accordingly, the folder icon positioned in the fixed selection-frame becomes an operation target selected by the user from all of folder icons during the folder selection. Accordingly, even when there are too many folder icons to be displayed on a single screen, a screen page does not change. Therefore, the user can immediately recognize a current position of the operation target.

### BRIEF DESCRIPTION OF THE DRAWINGS

The above and other features and advantages of the present invention will become more apparent by describing in detail preferred embodiments thereof with reference to the attached drawings in which:

FIG. 1 is a block diagram of a digital camera as a portable digital apparatus according to an embodiment of the present invention;

FIG. 2 is a flowchart of a control algorithm of a microcontroller shown in FIG. 1;

FIG. 3 is a flowchart of a setup control program shown in FIG. 2, according to a first embodiment of the present invention;

FIG. 4A illustrates content displayed on a screen of a color liquid crystal display (LCD) panel shown in FIG. 1 as a result of performing steps S401 through S403 shown in FIG. 3;

FIGS. 4B through 4G illustrate screens displayed when folder icons shown in FIG. 4A are moved to the left or to the right one-by-one by performing step S405 shown in FIG. 3;

FIG. 5 is a flowchart of the setup control program shown in FIG. 2, according to a second embodiment of the present invention;

FIG. 6A is a flowchart of an algorithm of a folder selection program shown in FIG. 5;

FIG. 6B is a flowchart of an algorithm of a item selection program shown in FIG. 5;

FIG. 6C is a flowchart of an algorithm of a data setup program shown in FIG. 5;

FIG. 7A illustrates content displayed on a screen of the color LCD panel shown in FIG. 1 as a result of performing steps S501 and S502 shown in FIG. 6A;

FIGS. 7B through 7D illustrate screens displayed when folder icons shown in FIG. 7A are moved to the left or to the right one by one by performing steps S503 through S506 shown in FIG. 6A;

FIG. 8A illustrate a screen displayed when step S531 shown in FIG. 6B was performed on the left screen of FIG. 7B;

FIG. 8B illustrate a screen displayed when step S571 shown in FIG. 6C was performed on the screen shown in FIG. 8A;

FIG. 9A illustrate a screen displayed when step S531 shown in FIG. 6B was performed on the right screen of FIG. 7B;

FIG. 9B illustrate a screen displayed when step S571 shown in FIG. 6C was performed on the screen shown in FIG. 9A;

FIG.10 A illustrate a screen displayed when step S531 shown in FIG. 6B was performed on the right screen of FIG. 7C;

FIG. 10B illustrate a screen displayed when step S571 shown in FIG. 6C was performed on the screen shown in FIG. 10A;

FIG. 11A illustrate a screen displayed when step S531 shown in FIG. 6B was performed on the right screen of FIG. 7D; and

FIG. 11 B illustrate a screen displayed when step S571 shown in FIG. 6C was performed on the screen shown in FIG. 1 1A.

### DETAILED DESCRIPTION OF THE INVENTION

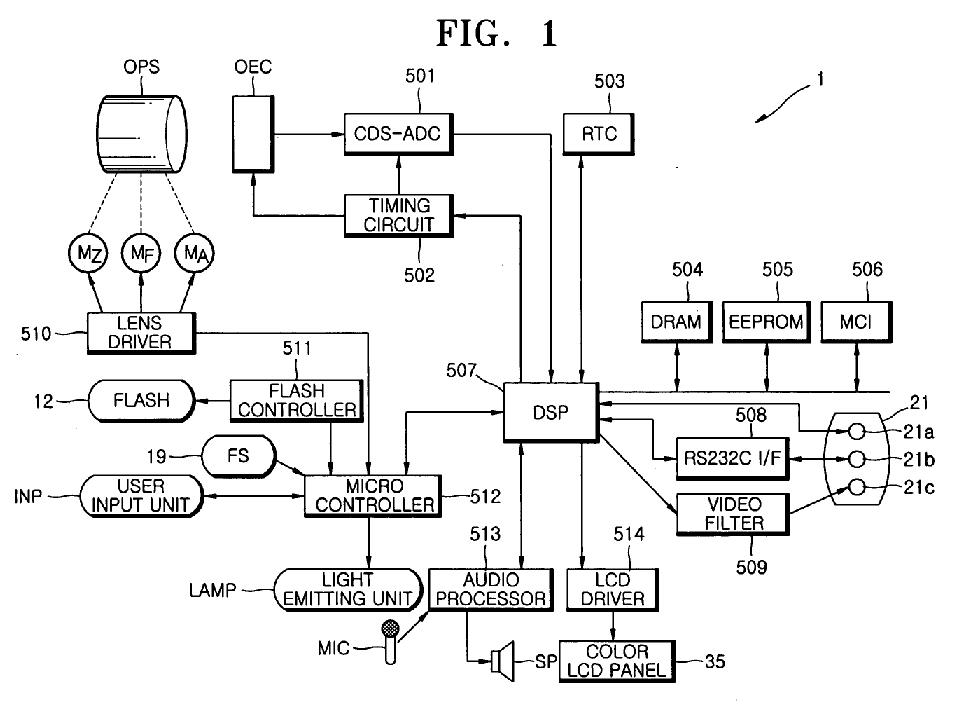

The entire structure of a digital camera 1 as a portable digital apparatus according to an embodiment of the present invention will be described below with reference to FIG. 1.

An optical system OPS including a lens unit, a filter unit, and an aperture optically processes light from a subject. The lens unit of the optical system OPS includes a zoom lens, a focus lens, and a compensating lens.

When a user presses a wide-angle zoom button or a telephoto zoom button included in a user input unit INP, a signal corresponding thereto is input to a microcontroller 512. Then, the microcontroller 512 controls a lens driver 510 to move a zoom motor M_{z} so that the zoom lens moves. In other words, when the wide-angle zoom button is pressed, a focal length of the zoom lens decreases so that a view angle becomes wider. When the telephoto zoom button is pressed, the focal length of the zoom lens increases so that the view angle becomes narrower. Here, since a position of the focus lens is adjusted under a state where a position of the zoom lens has been set, the view angle is rarely influenced by the position of the focus lens.

When a subject has been brought into a focus automatically or manually, a current position of the focus lens changes depending on a subject distance. Here, since the position of the focus lens is adjusted under a state where the position of the zoom lens has been set, the subject distance is influenced by the position of the zoom lens. In an automatic focusing mode, the micron controller 512 controls the lens driver 510 to drive a focus motor M_{F}. Then, the focus lens moves from the head to the tail of a motion area. During this movement, the position of the focus lens, e.g., a step number of the focus motor M_{F}, giving a largest amount of high frequency to an image signal is set.

Because the compensating lens of the optical system OPS compensates for an entire refractive index, the compensating lens is not separately driven.

A motor M_{A} drives the aperture. The rotation angle of the aperture driving motor M_{A} changes depending on whether the digital camera 1 is set to a specified exposure mode. The specified exposure mode sets an amount of exposure for the digital camera 1 with respect to the average luminance of a specified detection area when a partial area desired by a user in a subject area matches the specified detection area displayed on a color liquid crystal display (LCD) panel 35 of the digital camera 1.

An optical low pass filter (OLPF) included in the filter unit of the optical system OPS removes optical noise of high frequency. In addition, an infrared cut filter (IRF) included in the filter unit blocks infrared components of incident light.

An optoelectric converter OEC implemented by means of a charge coupled device (CCD) or a complementary metal-oxide-semiconductor (CMOS) converts light from the optical system OPS into an electric analog signal. A digital signal processor (DSP) 507 controls a timing circuit 502 to control the optoelectric converter OEC and a correlated double sampler and analog-to-digital converter (CDS-ADC) 501. The CDS-ADC 501 processes the analog signal received from the optoelectric converter OEC to remove high-frequency noise and adjust the amplitude. The CDS-ADC 501 then converts the analog signal into a digital signal. A real time clock (RTC) 501 provides time information to the DSP 507. The DSP 507 processes the digital signal received from the CDS-ADC 501 to generate a digital image signal divided into a luminance signal and a chrominance signal.

A light emitting unit LAMP driven by the microcontroller 512 includes a self-timer lamp, an auto-focus lamp, and a flash standby lamp. The user input unit INP includes a shutter button, a mode dial, a function selection button, a function block button, a monitor button, an OK/delete button, an enter/play button, a menu button, a wide-angle zoom button, a telephoto zoom button, an up button, a right button, a down button, and a left button. The up, right, down, and left buttons and the enter/play button are directly related to the method of controlling a portable digital apparatus according to the present invention.

The digital image signal from the DSP 507 is temporarily stored in a dynamic random access memory (DRAM) 504. An algorithm and setup data which are necessary for the operation of the DSP 507 are stored in an electrically erasable programmable read only memory (EEPROM) 505. A memory card is removably installed in a memory card interface (MCI) 506.

The digital image signal from the DSP 507 is input to an LCD driver 514, and therefore, an image is displayed on the color LCD panel 35.

In the meantime, the digital image signal from the DSP 507 can be transmitted in serial communication via a universal serial bus (USB) connector 21a or an RS232C interface (I/F) 508 and its connector 21b, or can be transmitted as a video signal via a video filter 509 and a video output unit 21c.

An audio processor 513 outputs audio signals received from a microphone MIC to the DSP 507 or a speaker SP and outputs audio signals received from the DSP 507 to the speaker SP.

Meanwhile, the microcontroller 512 controls a flash controller 511 according to a signal from a flashlight sensor (FS) 19 to drive a flash 12. The microcontroller 512 also performs an algorithm according to an embodiment of the present invention that will be described below.

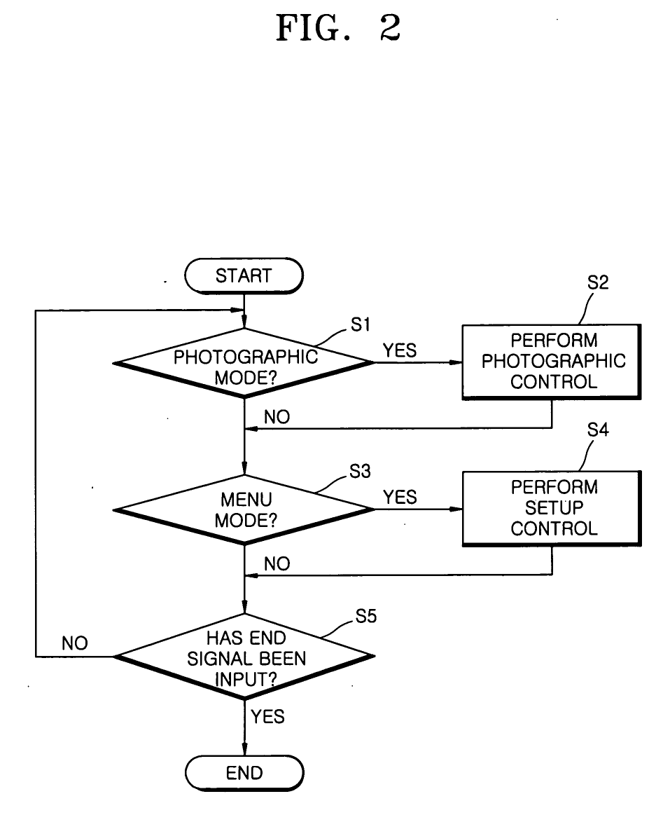

Referring to FIG. 2, when a photographic mode is set by a user's operation in step Si, the microcontroller 512 performs a photographic control according to the user's operation in step S2. When a menu mode is set by the user's operation in step S3, the microcontroller 512 performs a setup control to set operating conditions of the digital camera 1 according to the user's operations in step S4. Steps S1 through S4 are repeated until an external end signal is input in step S5.

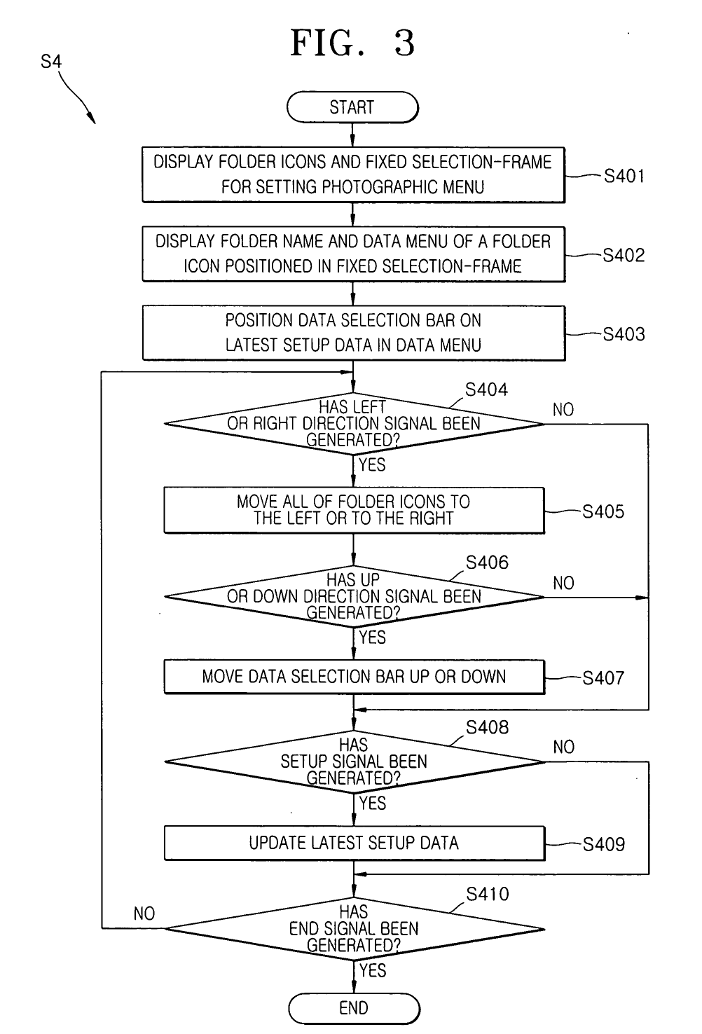

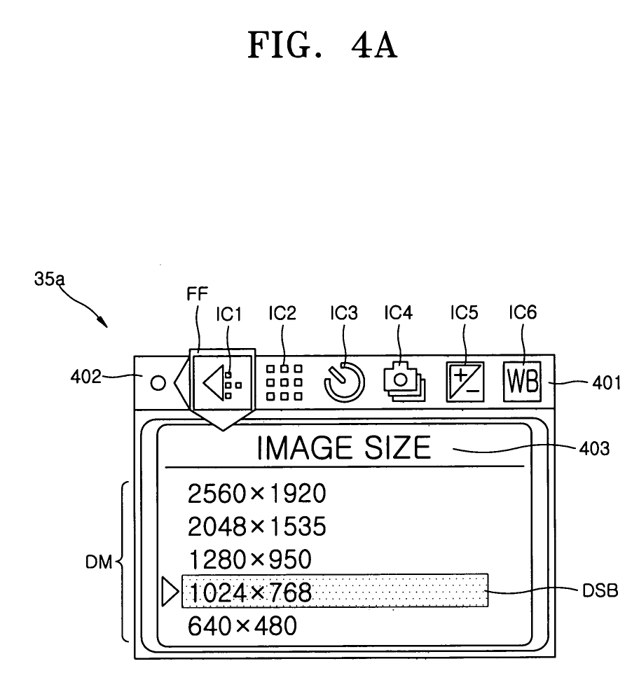

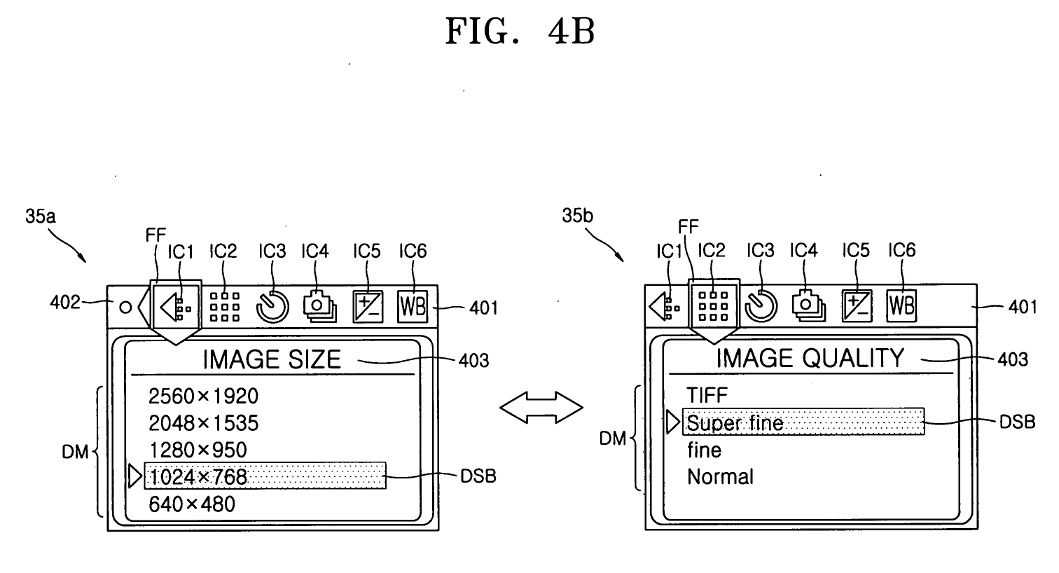

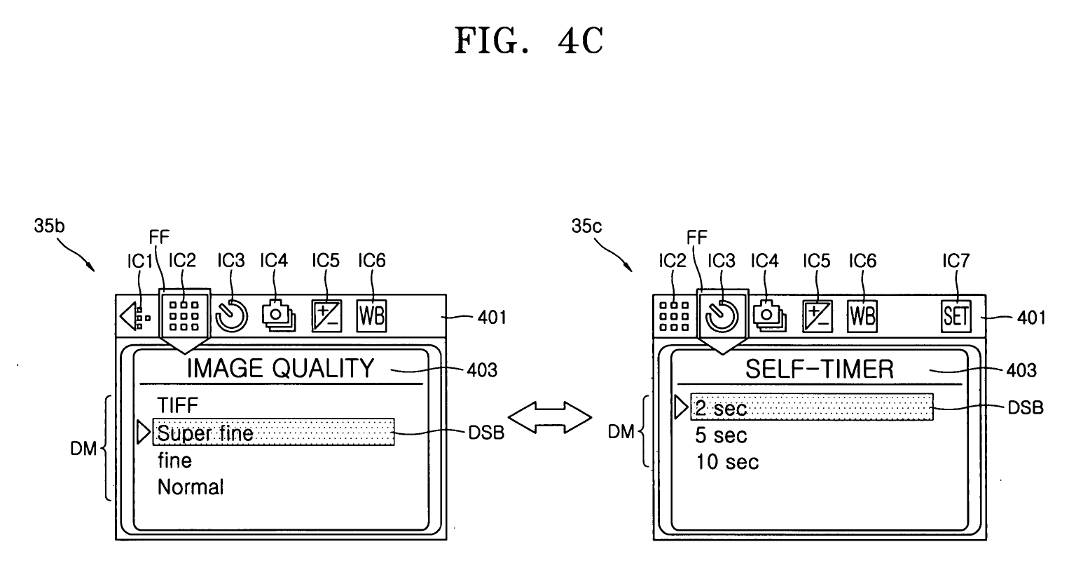

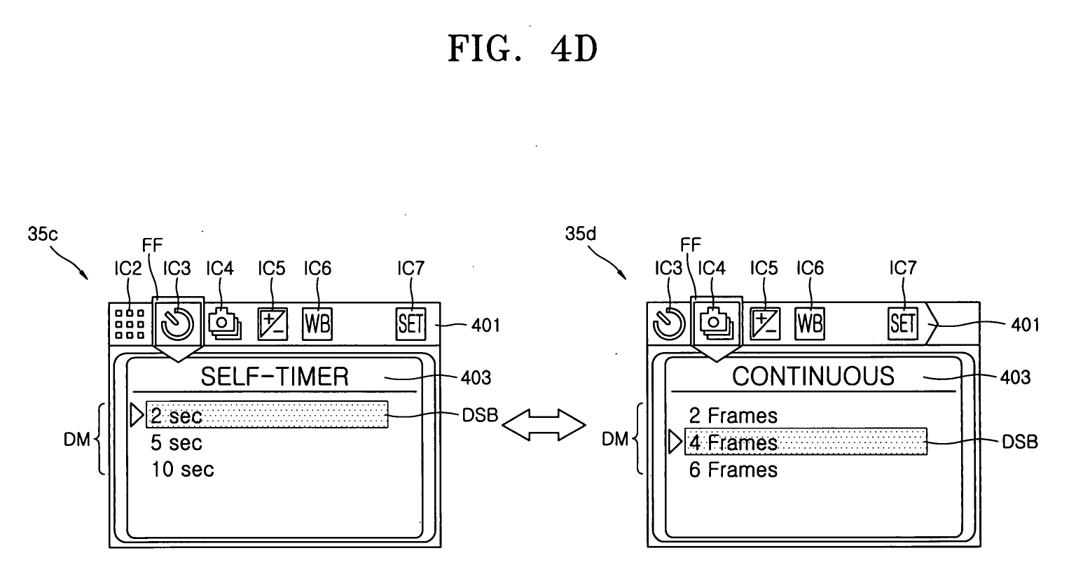

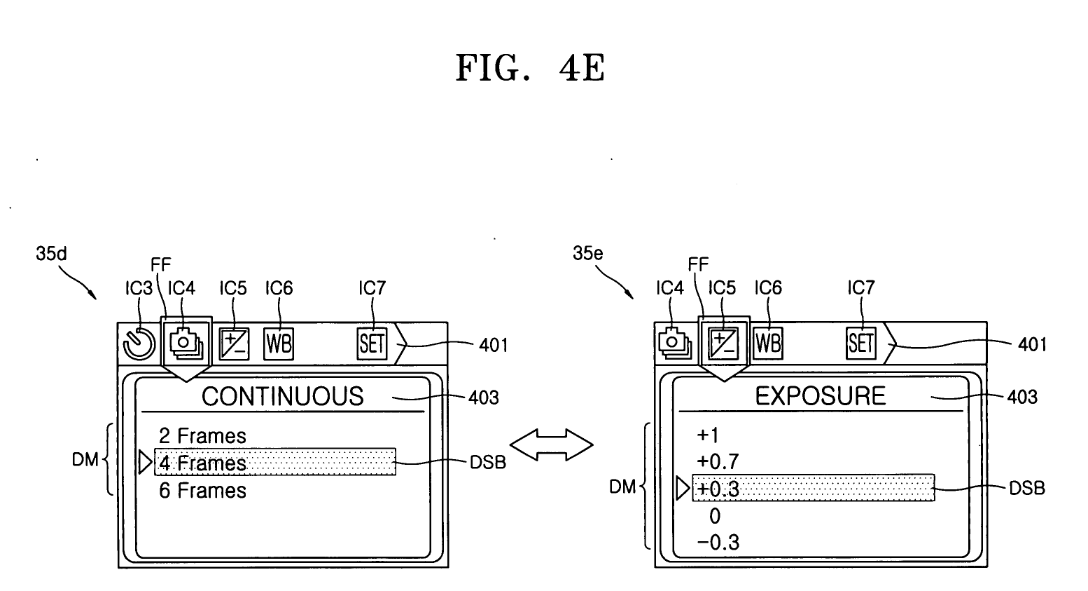

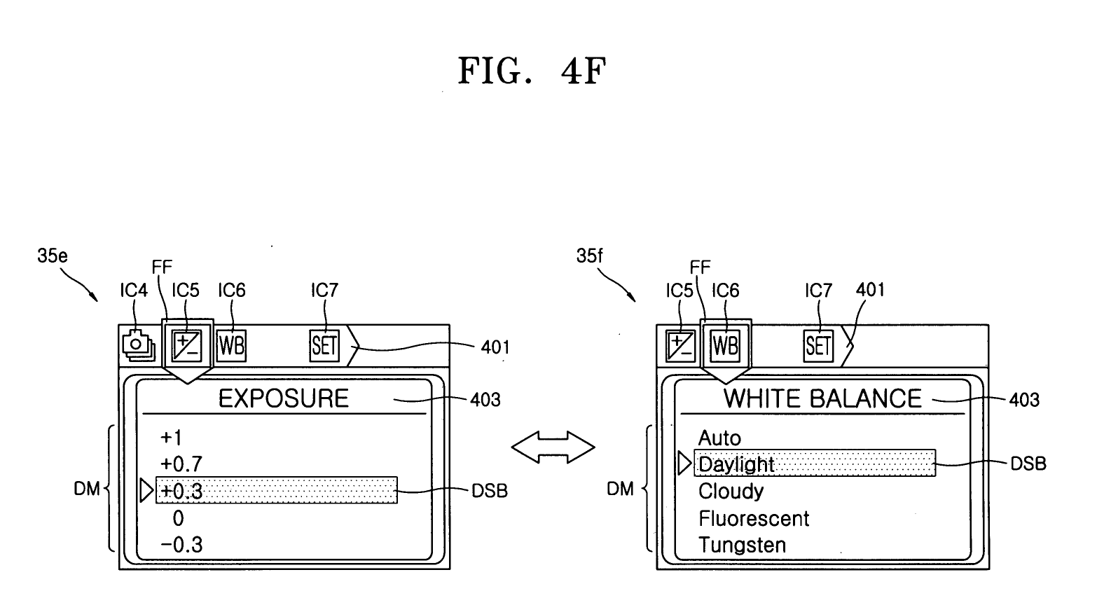

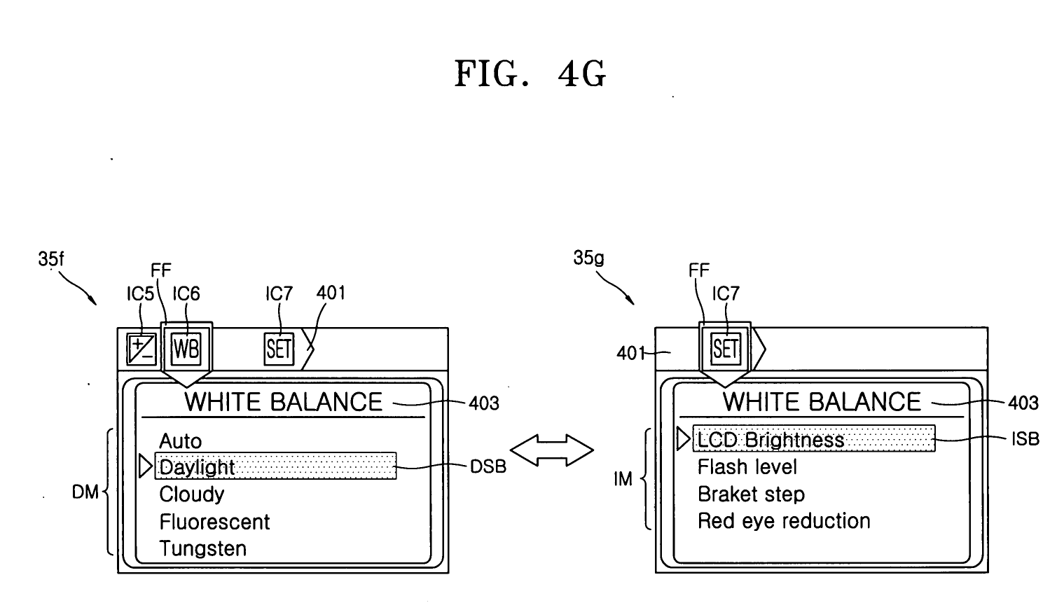

FIG. 4A illustrates content displayed on a screen 35a of the color LCD panel 35 shown in FIG. 1 as a result of performing steps S401 through S403 shown in FIG. 3. FIGS. 4B through 4G illustrate screens displayed when folder icons IC1 through IC6 shown in FIG. 4A are moved to the left or to the right one by one by performing step S405 shown in FIG. 3. In FIGS. 4A through 4G, the same reference numerals denote the items having the same functions. Reference numeral 401 denotes an icon-menu bar, and reference numeral 402 denotes an initial point. Hereinafter, the setup control program performed in step S4 shown in FIG. 2, according to a first embodiment of the present invention, will be described with reference to FIGS. 3 through 4G. The first embodiment is used to set a photographic menu of the digital camera 1 shown in FIG. 1 as an example of a portable digital apparatus.

Folder icons IC1 through IC6 shown in FIG. 4A and a fixed selection-frame FF for setting the photographic menu are displayed in step S401. A folder name 403 and a data menu DM shown in FIG. 4A of the folder icon IC1 positioned in the fixed selection-frame FF are displayed in step S402. Next, a data selection bar DSB shown in FIG. 4A is positioned on the most recent setup data, 1024×768, in the data menu DM in step S403.

Next, when a left direction signal is generated by the user pressing the left button, all of the folder icons IC1 through IC6 are moved to the left in step S404. When a right direction signal is generated by the user pressing the right button, all of the folder icons ICl through IC6 are moved to the right in step S404. Accordingly, even when there are too many folder icons to be displayed on a single screen, the folder icons are displayed without changing a screen page. As a result, the user can immediately recognize the current position of an operation target. Here, the folder name 403 and the data menu DM of a folder icon positioned in the fixed selection-frame FF are displayed, as shown in FIGS. 4B through 4G. In addition, the data selection bar DSB is positioned on the latest setup data in the displayed data menu DM, as shown in FIGS. 4B through 4G.

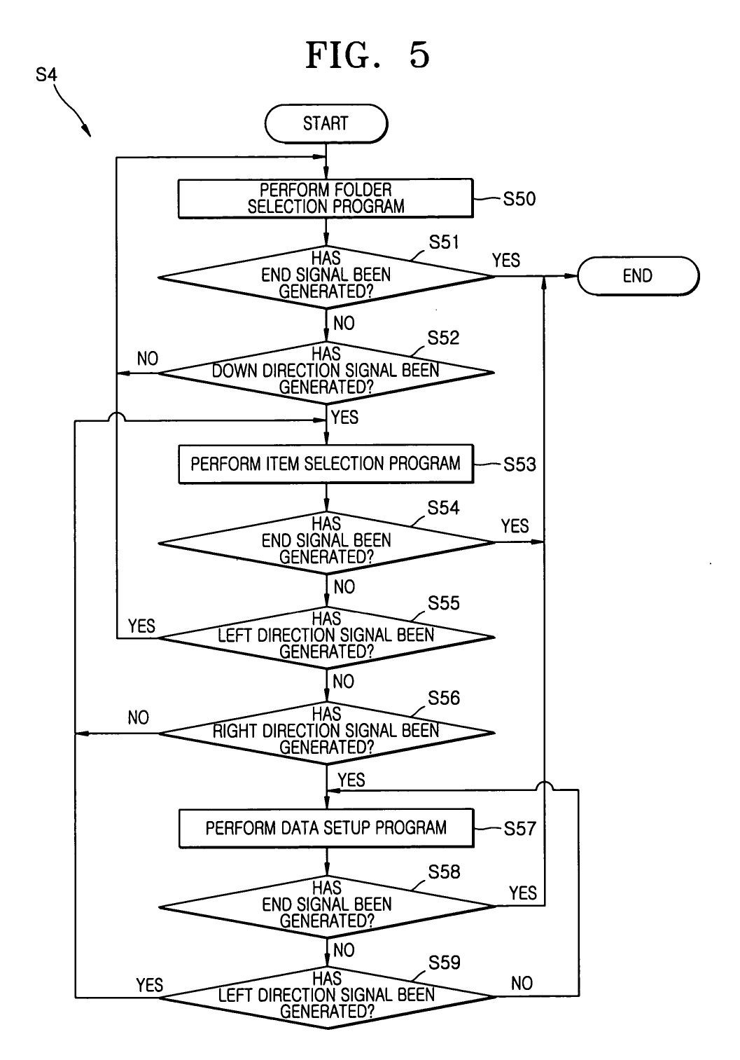

Referring to FIGS. 4B through 4F, the plurality of the folder icons IC1 through IC6 displayed on screens 35a through 35f of the color LCD panel 35 shown in FIG. 1 are arranged in a line in a horizontal direction of the color LCD panel 35, and the data menu DM of a folder icon positioned in the fixed selection-frame FF is displayed below the folder icons IC1 through IC6. In the right screen 35g of FIG. 4G, an item menu IM including items of a folder icon IC7 positioned in the fixed selection-frame FF is displayed below the folder icon IC7. A control method on the right screen 35g of FIG. 4G will be described later as a second embodiment with reference to FIGS. 5 through 11 B.

Next, when a down direction signal is generated by the user pressing the down button, the data selection bar DSB is moved down in step S407. When an up direction signal is generated by the user pressing the up button, the data selection bar DSB is moved up in step S407. Next, when a setup signal is generated by the user pressing the enter button in step S408, the latest setup data is updated with data corresponding to the item on which the data selection bar DSB is positioned (Step S409).

Steps S404 through S409 are repeated until an end signal is generated in step S410.

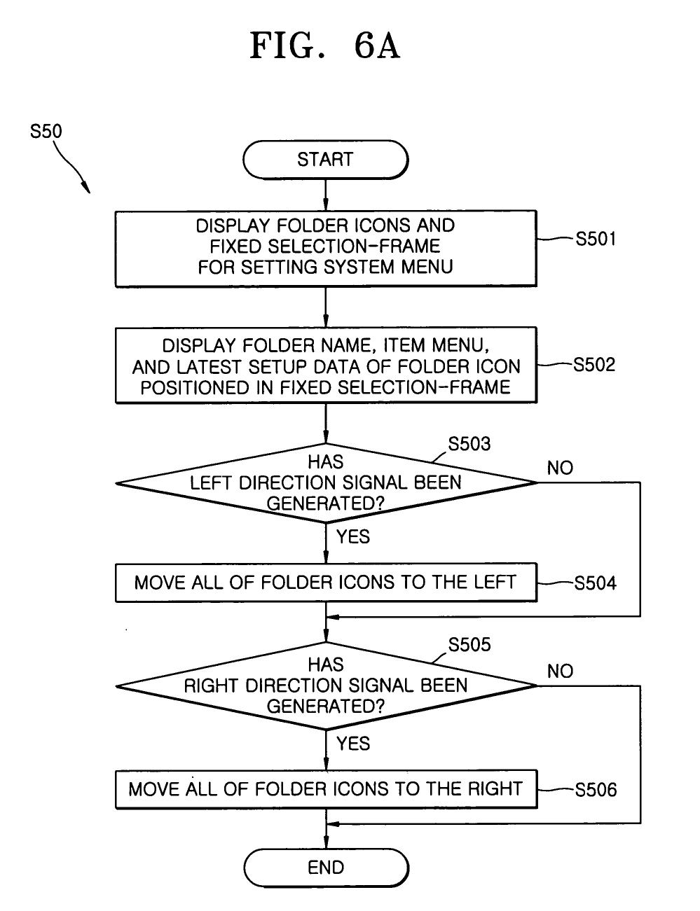

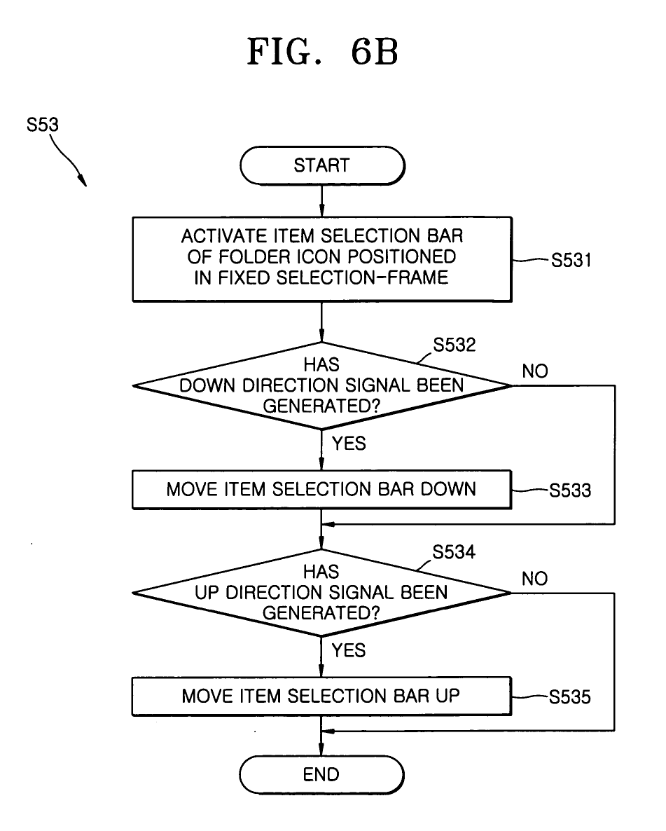

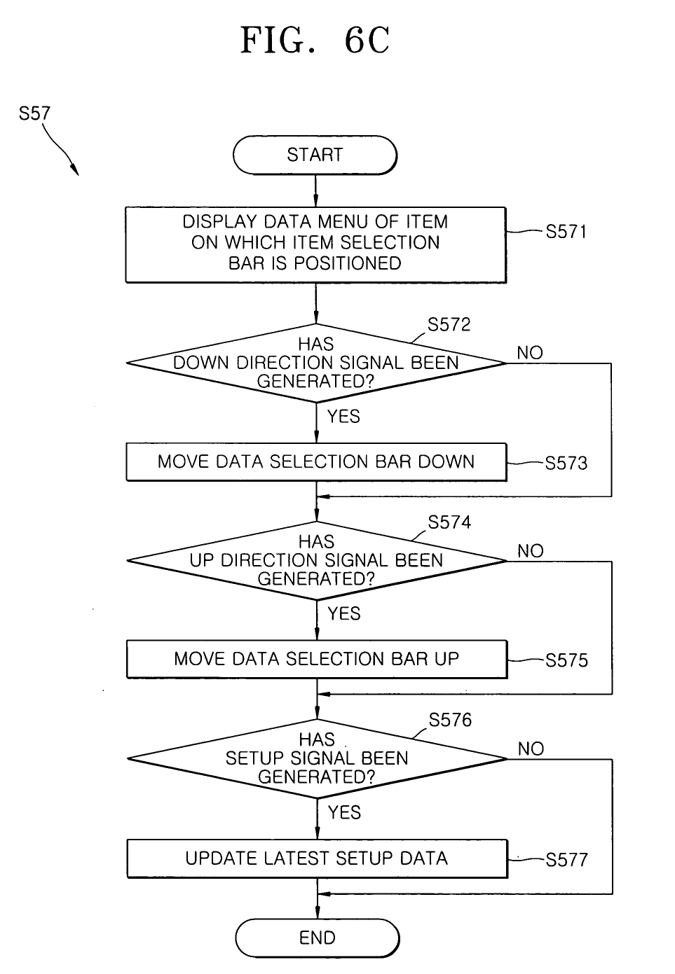

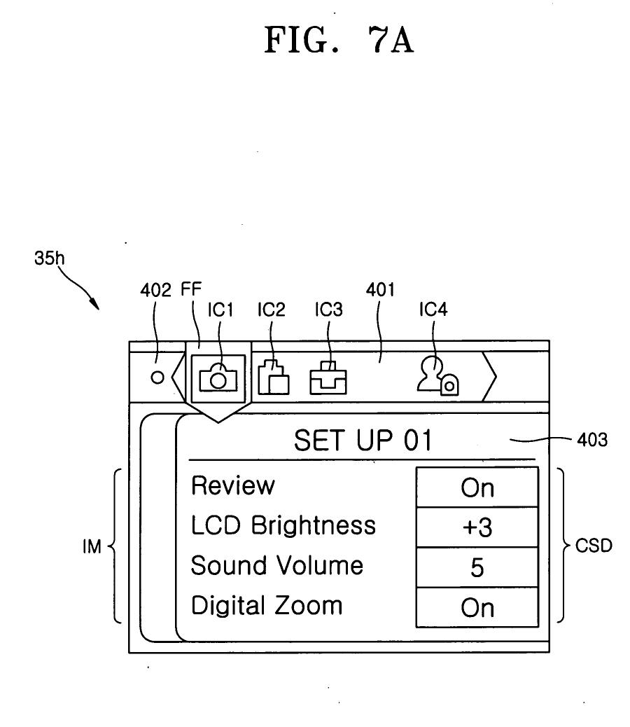

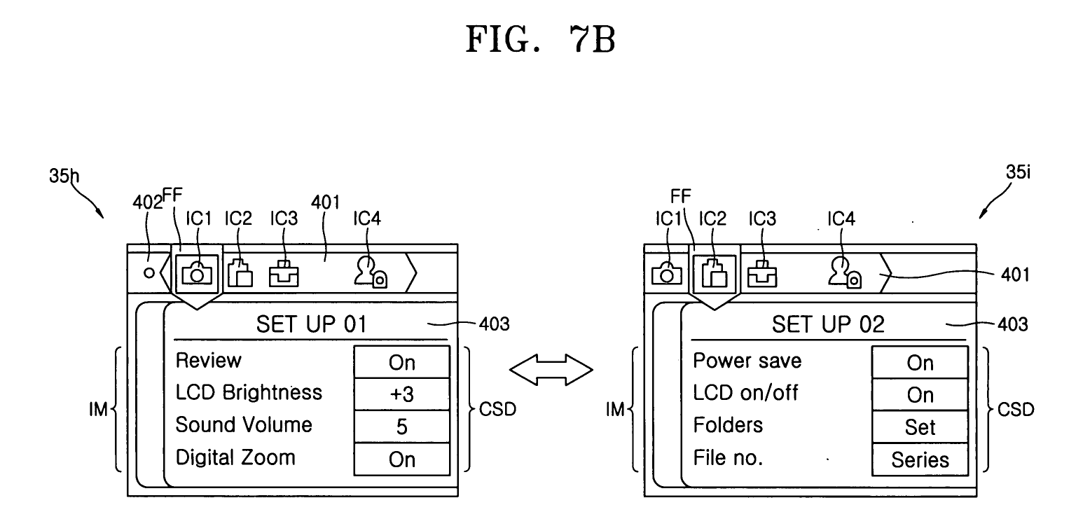

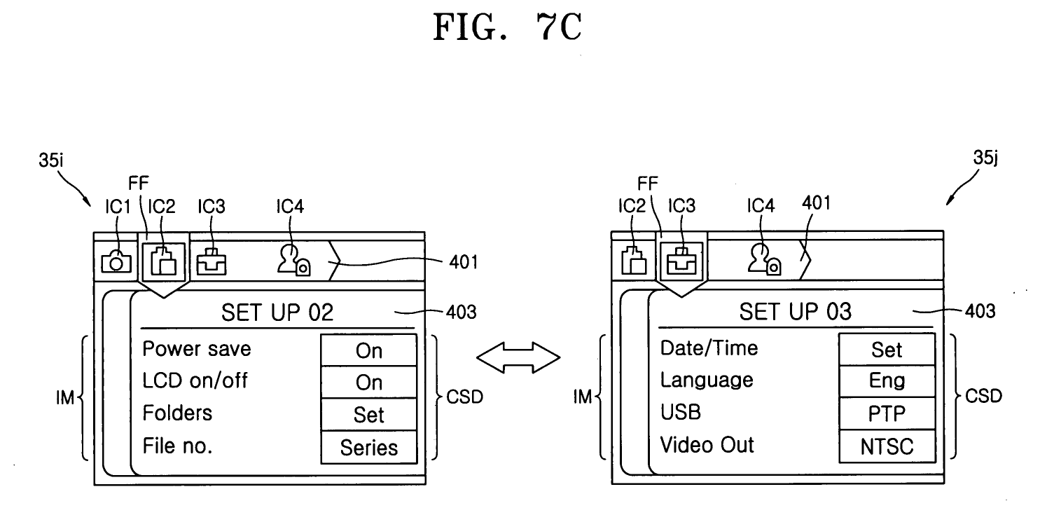

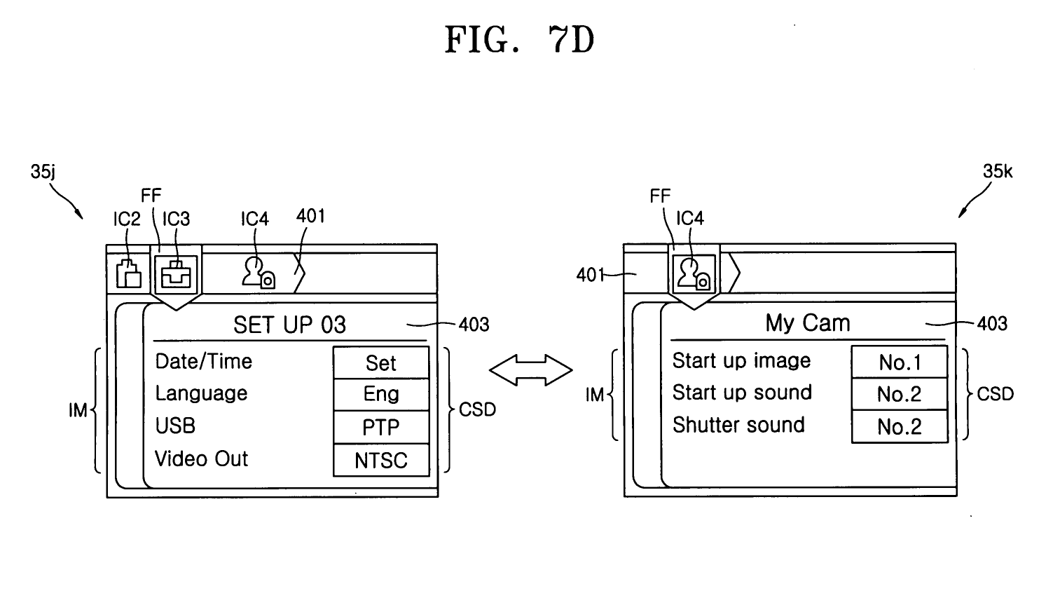

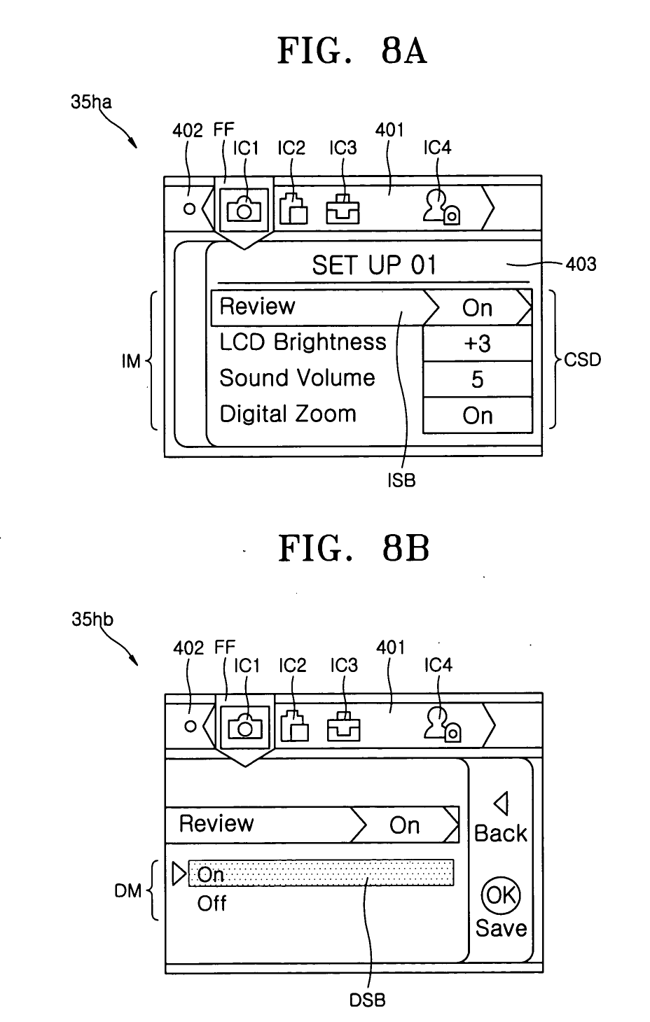

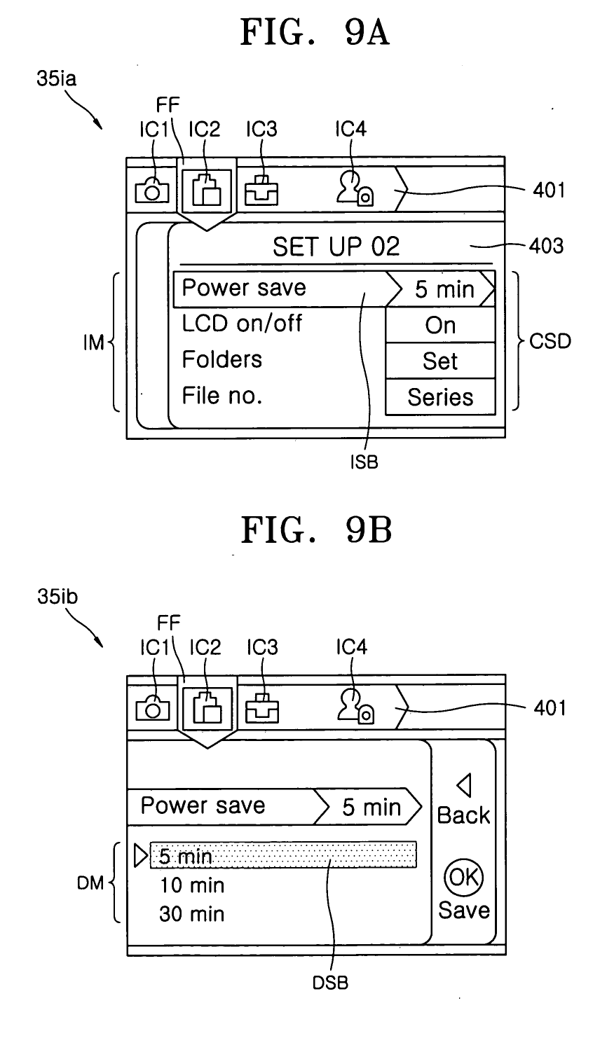

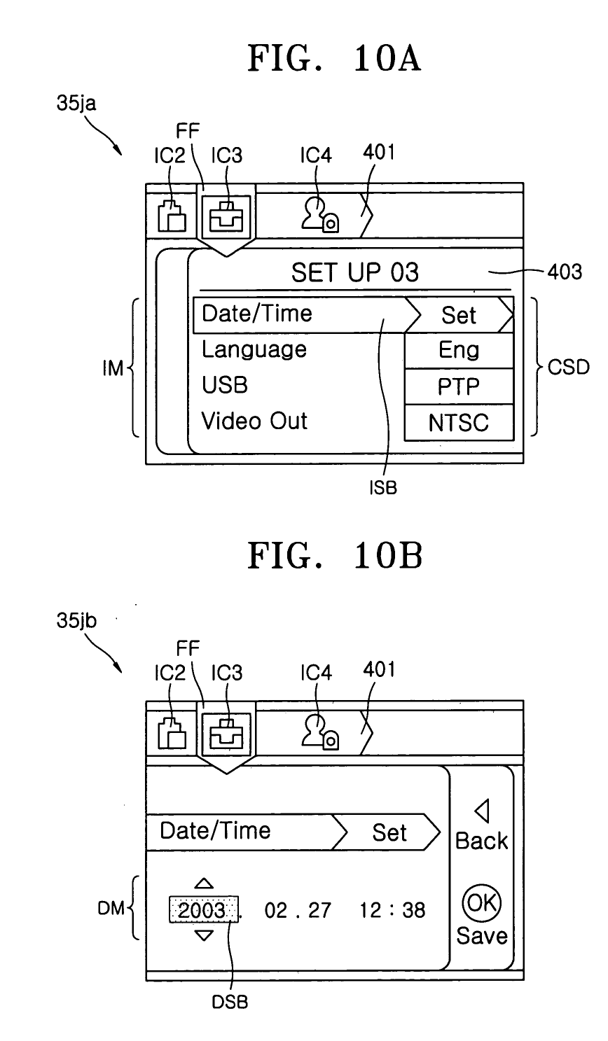

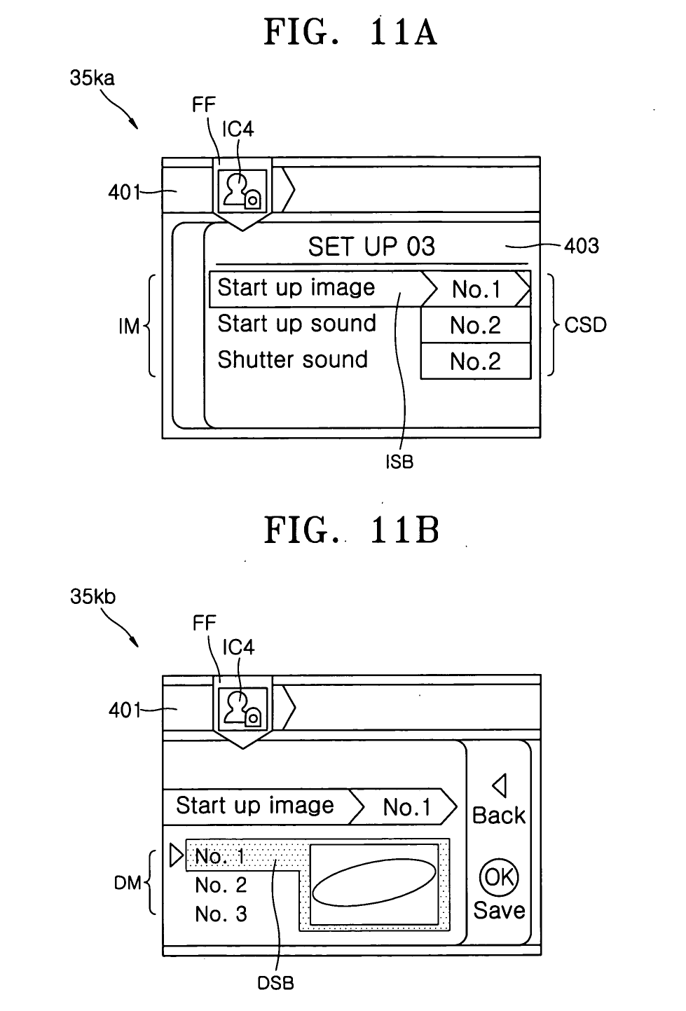

FIG. 5 is a flowchart of the setup control program performed in step S4 shown in FIG. 2, according to a second embodiment of the present invention. FIG. 6A is a flowchart of an algorithm of a folder selection program performed in step S50 shown in FIG. 5. FIG. 6B is a flowchart of an algorithm of an item selection program performed in step S53 shown in FIG. 5. FIG. 6C is a flowchart of an algorithm of a data setup program performed in step S57 shown in FIG. 5. FIG. 7A illustrates content displayed on a screen 35h as a result of performing steps S501 and S502 shown in FIG. 6A. FIGS. 7B through 7D illustrate screens 35h through 35k displayed when folder icons IC1 through IC4 shown in FIG. 7A are moved to the left or to the right one by one by performing steps S503 through S506 shown in FIG. 6A. FIG. 8A illustrate a screen 35ha displayed when step S531 shown in FIG. 6B was performed on the left screen 35h of FIG. 7B. FIG. 8B illustrate a screen 35hb displayed when step S571 shown in FIG. 6C was performed on the screen 35ha shown in FIG. 8A. FIG. 9A illustrates a screen 35ia displayed when step S531 shown in FIG. 6B has been performed on the right screen 35i of FIG. 7B. FIG. 9B illustrates a screen 35ib displayed when step S571 shown in FIG. 6C has been performed on the screen 35ia shown in FIG. 9A. FIG. 10A illustrates a screen 35ja displayed when step S531 shown in FIG. 6B has been performed on the right screen 35j of FIG. 7C. FIG. 10B illustrates a screen 35jb displayed when step S571 shown in FIG. 6C has been performed on the screen 35ja shown in FIG. 10A. FIG. 1 1A illustrates a screen 35ka displayed when step S531 shown in FIG. 6B has been performed on the right screen 35k of FIG. 7D. FIG. 11 B illustrates a screen 35kb displayed when step S571 shown in FIG. 6C has been performed on the screen 35ka shown in FIG. 1 1A. In FIGS. 7A through 11 B, the same reference numerals denote items having the same functions. In FIGS. 7A through 11 B, reference numeral 401 denotes an icon-menu bar, and reference numeral 402 denotes an initial point.

Hereinafter, the setup control program performed in step S4 shown in FIG. 2, according to the second embodiment of the present invention, will be described with reference to FIGS. 5 through 11 B. The second embodiment sets a system menu of the digital camera 1 shown in FIG. 1 as an example of a portable digital apparatus.

Referring to FIG. 5, step S4 includes performing a folder selection program in step S50. If it is determined that an end signal has been generated in step S51, the setup control program ends. However, when the end signal has not been generated, it is determined whether a down direction signal has been generated by a user pressing the down button in step S52. Next, if it is determined that the down direction signal has been generated, the item selection program is performed in step S53. If it is determined that the down direction signal has not been generated, the folder selection program is performed again in step S50.

After step S53, if it is determined that the end signal has been generated in step S54, the setup control program ends. When it is determined that the end signal has not been generated, then in step S55 it is determined whether a left direction signal has been generated by the user pressing the left button. If it is determined that the left direction signal has been generated, the folder selection program is performed again in step S50. In this case, the item selection screen 35ha shown in FIG. 8A is converted back to the left screen 35h of FIG. 7B, the item selection screen 35ia shown in FIG. 9A is converted back to the right screen 35i of FIG. 7B, the item selection screen 35ja shown in FIG. 10A is converted back to the right screen 35j of FIG. 7C, and the item selection screen 35ka shown in FIG. 11A is converted back to the right screen 35k of FIG. 7D.

However, when in step S55 the determination is made that the left direction signal has not been generated, it is determined in step S56 whether a right direction signal has been generated by the user pressing the right button. When it is determined that the right direction signal has been generated, the data setup program is performed in step S57. If it is determined that the right direction signal has not been generated, the item selection program is performed again in step S53.

After step S57, if it is determined that the end signal has been generated in step S58, the setup control program ends. However, when it is determined that the end signal has not been generated, it is determined in step S59 whether the left direction signal has been generated by the user pressing the left button. Next, if it is determined that the left direction signal has been generated, the item selection program is performed again in step S53. However, when it is determined that the left direction signal has not been generated, the data setup program is performed again in step S57. When the item selection program is performed again in step S53 in response to the left direction signal generated in step S59, the data selection screen 35hb shown in FIG. 8B is converted back to the item selection screen 35ha shown in FIG. 8A, the data selection screen 35ib shown in FIG. 9B is converted back to the item selection screen 35ia shown in FIG. 9A, the data selection screen 35jb shown in FIG. 10B is converted back to the item selection screen 35ja shown in FIG. 10A, and the data selection screen 35kb shown in FIG. 11 B is converted back to the item selection screen 35ka shown in FIG. 11A.

To perform the folder selection program in step S50, referring to FIG. 6A, the folder icons IC1 through IC4 and a fixed selection-frame FF for setting a system menu are displayed in step S501. A folder name 403, an item menu IM, and a latest setup data CSD of a folder icon (IC1 in FIG. 7A) positioned in the fixed selection-frame FF are displayed in step S502. Here, in the screens 35h through 35k (shown in FIGS. 7A through 7D) of the color LCD panel 35 shown in FIG. 1, a plurality of the folder icons IC1 through IC4 are arranged in a line in the horizontal direction of the color LCD panel 35. The folder name 403, the item menu IM, and the latest setup data CSD of a folder icon positioned in the fixed selection-frame FF are displayed below the folder icons IC1 through IC4. Next, when it is determined that the left direction signal has been generated by the user pressing the left button in step S503, all of the icon folders IC1 through IC4 are moved to the left as shown in FIGS. 7B through 7D in step S504. When it is determined that the right direction signal has been generated by the user pressing the right button in step S505, all of the icon folders IC1 through IC4 are moved to the right in step S506. Accordingly, even when there are too many folder icons to be displayed on a single screen, a screen page does not change. Therefore, the user can immediately recognize a current position of an operation target.

To perform the item'selection program in step S53, referring to FIG. 6B, an item selection bar ISB of a folder icon positioned in the fixed selection-frame FF is activated as shown in FIGS. 8A, 9A, 10A, and 11A in step S531. Next, when it is determined that the down direction signal has been generated by the user pressing the down button in step S532, an item selection bar ISB is moved down in step S533. When it is determined that an up direction signal has been generated by the user pressing the up button in step S534, the item selection bar ISB is moved up in step S535.

To perform the data setup program in step S57, referring to FIG. 6C, the data menu DM of an item on which the item selection bar ISB is positioned is displayed as shown in FIGS. 8B, 9B, 10B, and 11B in step S571. Next, when it is determined that the down direction signal has been generated by the user pressing the down button in step S572, a data selection bar DSB is moved down in step S573. When it is determined that the up direction signal has been generated by the user pressing the up button in step S574, the data selection bar DSB is moved up in step S575. Next, when it is determined that a setup signal has been generated by the user pressing the enter button in step S576, the latest setup data CSD is updated with data on which the data selection bar DSB is positioned in step S577.

As described above, in the present invention, a folder icon positioned in a fixed selection-frame becomes an operation target selected by a user from all of folder icons during a folder selection. Accordingly, even when there are too many folder icons to be displayed on a single screen, a screen page does not change. Therefore, the user can immediately recognize a current position of an operation target.

Although a few embodiments of the present invention have been shown and described, it will be understood by those skilled in the art that changes may be made in these elements without departing from the spirit and scope of the invention.

What is claimed is:

1. A method of controlling a portable digital apparatus that includes a display panel, the method comprising:
displaying at least one folder icon out of a plurality of folder icons on the display panel;
displaying a fixed selection-frame whose position is fixed on a screen of the display panel;
moving folder icons according to the user's operation so that each folder icon may be positioned in the fixed selection-frame in a certain order; and
selecting a folder icon by stopping movement when the selected folder icon is positioned in the fixed selection-frame.

2. The method of claim 1, further comprising:
displaying a data menu of the folder icon that is positioned in the fixed selection-frame.

3. The method of claim 2, further comprising: moving a data selection marker to select data in the data menu.

4. The method of claim 2, further comprising:
displaying the plurality of folder icons in a line in a horizontal direction of the display panel; and
displaying the data menu of the folder icon positioned in the fixed selection-frame below the folder icons.

5. The method of claim 4, further comprising:
moving all of the folder icons to the left when a left direction signal is generated by the user's operation; and
moving all of the folder icons to the right when a right direction signal is generated by the user's operation.

6. The method of claim 4, further comprising:
moving a data selection marker down to select data in the data menu when a down direction signal is generated by the user's operation; and
moving the data selection marker up to select data in the data menu when an up direction signal is generated by the user's operation.

7. The method of claim 2, further comprising:
updating the most recent setup data with data on which a data selection marker is positioned when a setup signal is generated by the user's operation.

8. A method of controlling a portable digital apparatus that includes a display panel, the method comprising:
displaying at least one folder icon out of a plurality of folder icons on the display panel;
displaying a fixed selection-frame whose position is fixed on a screen of the display panel;
moving folder icons according to the user's operation so that each folder icon may be positioned in the fixed selection-frame in a certain order;
selecting a folder icon by stopping movement when the selected folder icon is positioned in the fixed selection-frame; and
displaying an item menu of the folder icon that is positioned in the fixed selection-frame.

9. The method of claim 8, further comprising:
displaying the most recent setup data for each item in the item menu.

10. The method of claim 8, further comprising:
activating an item selection marker.

11. The method of claim 10, further comprising:
moving the item selection marker to select an item in the item menu.

12. The method of claim 11, further comprising:
displaying a data menu of the item which is highlighted by the item selection marker.

13. The method of claim 12, further comprising:
activating a data selection marker.

14. The method of claim 13, further comprising:
moving a data selection marker to select data in the data menu.

15. The method of claim 14, further comprising:
updating latest setup data with the data on which the data selection marker is positioned.

16. The method of claim 8, further comprising:
displaying at least some of the plurality of folder icons in a line in a horizontal direction of the display panel; and
displaying, below the folder icons, an item menu of the folder icon positioned in the fixed selection-frame and most recent setup data of each item in the item menu.

17. The method of claim 16, further comprising:
moving all of the folder icons to the left when a left direction signal is generated by the user's operation; and
moving all of the folder icons to the right when a right direction signal is generated by the user's operation.

18. The method of claim 17, further comprising:
activating an item selection marker positioned on an item in the item menu when a down direction signal is generated by the user's operation.

19. The method of claim 18, further comprising:
moving the item selection marker down when the down direction signal is generated by the user's operation; and
moving the item selection marker up when an up direction signal is generated by the user's operation.

20. The method of claim 19, further comprising:
when the item selection marker is activated, activating control of folder selection when the left direction signal is generated by the user's operation; and
displaying a data menu of the item on which the item selection marker is positioned when the right direction signal is generated.

21. The method of claim 20, further comprising:
displaying the data menu below the folder icons in a vertical direction;
moving a data selection marker down to select data in the data menu when the down direction signal is generated by the user's operation; and
moving the data selection marker up to select data in the data menu when the up direction signal is generated by the user's operation.

22. The method of claim 21, further comprising:
updating latest setup data with the data on which the data selection marker is positioned when a setup signal is generated by the user's operation.

23. The method of claim 21, further comprising:
displaying the item menu again and activating the item selection marker when the left direction signal is generated by the user's operation.
